(19) United States
(12) Patent Application Publication
(10) Pub. No.: US 2009/0142646 A1
(43) Pub. Date: Jun. 4, 2009

(54) DIRECT METHANOL FUEL CELL STACK INCLUDING FLOW RESTRICTOR AND DIRECT METHANOL FUEL CELL INCLUDING THE SAME

(75) Inventors: Sang-kyun KANG, Seoul (KR); Young-Seung Na, Suwon-si (KR); Kyoung-hwan Ohoi, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/193,188

(22) Filed: Aug. 18, 2008

(30) Foreign Application Priority Data
Dec. 4, 2007 (KR) 2007-124902

(51) Int. Cl. H01M 2/00

(52) U.S. Cl. 429/34

(57) ABSTRACT

A direct methanol fuel cell (DMFC) that includes: an anode, a cathode, and a membrane disposed therebetween; a bipolar plate having a flow channel to supply a fluid to the anode; and a flow restrictor installed in the flow channel, to restrict the flow of the fluid.

### CROSS-REFERENCE TO RELATED APPLICATIONS

This application claims the benefit of Korean Patent Application No. 2007-124902, filed on Dec. 4, 2007, in the Korean Intellectual Property Office, the disclosure of which is incorporated herein in its entirety by reference.

### BACKGROUND OF THE INVENTION

1. Field of the Invention

Aspects of the present invention relate to a direct methanol fuel cell (DMFC) that includes a flow restrictor.

2. Description of the Related Art

A fuel cell is an electric generator that changes chemical energy of a fuel into electrical energy, through a chemical reaction. The fuel cell can continuously generate electricity, as long as the fuel is supplied. A direct methanol fuel cell (DMFC) generates electricity through a reaction between methanol supplied to an anode of a cell, and oxygen supplied to a cathode of the cell. At the anode side, electrons are generated through the following Reaction 1, and the electrons participate in the following Reaction 2, at the cathode side, by moving to the cathode along a electronically conductive path. When a load is applied to the path, the electrons can be applied to a load.

CH₃OH+H₂O⇄CO₂+6H⁺+6e⁻ [Reaction 1]

3/2O₂+6H⁺+6e⁻⇄3H₂O [Reaction 2]

An assembly in which the anode and the cathode are stacked on either side of an electrolyte membrane, to cause the chemical reactions 1 and 2, is referred to as a membrane electrode assembly (MEA). A single MEA does not generate sufficient electricity for most applications, and thus, electricity is generated by a plurality of MEAs disposed as a stack. Thus, in a DMFC, electricity is generated by reacting methanol in the stack.

### SUMMARY OF THE INVENTION

Aspects of the present invention provide a direct methanol fuel cell (DMFC) having a flow restrictor that is installed in a flow channel, to restrict the flow of a fluid.

According to an aspect of the present invention, there is provided a direct methanol fuel cell (DMFC), comprising: an MEA having an anode, an electrolyte membrane, and a cathode, which are stacked together; a bipolar plate having a flow channel to supply a fluid to the anode; and a flow restrictor installed in the flow channel, to restrict the flow of the fluid.

According to an aspect of the present invention, there is provided a direct methanol fuel cell (DMFC) comprising: a stack of unit cells that each comprise an MEA, a bipolar plate having a flow channel to supply a fluid to the anode; and a flow restrictor installed in the flow channel, to restrict the flow of the fluid; and a fuel supply unit that supplies a fuel to the stack.

According to an aspect of the present invention, the flow restrictor may be formed at an inlet side of the flow channel.

According to an aspect of the present invention, the flow restrictor may comprise capillaries or a wick bundle, through which the fluid flows.

According to an aspect of the present invention, the flow restrictor may comprise a porous member. The porous member may be a portion of a gas diffusion layer formed in an anode. A catalyst layer may not be disposed adjacent to the portion of the gas diffusion layer.

According to an aspect of the present invention, the flow restrictor may inhibit the flow of a fluid at the inlet side of the flow channel, so that a pressure difference between an inlet and an outlet of the flow channel, before commencing an electricity generation reaction, is greater than a maximum deviation of the pressure difference between the inlet and the outlet of the flow channel, while performing the electricity generation reaction.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent, and more readily appreciated, from the following description of the exemplary embodiments, taken in conjunction with the accompanying drawings, of which:

FIG. 1 is an exploded perspective view of a structure of a unit cell of a direct methanol fuel cell (DMFC), according to an exemplary embodiment of the present invention;

FIG. 2 is a magnified perspective view of portion A, in FIG. 1;

FIG. 3 is a cross-sectional view of a structure of an anode of FIG. 1;

FIG. 4 is a schematic drawing of a structure of a stack, in which the unit cells of FIG. 1 are stacked;

FIGS. 5A and 5B respectively are graphs showing pressure differences that can occur in DMFCs without and with a flow restrictor, according to an exemplary embodiment of the present invention; and

FIGS. 6 and 7 respectively are a perspective view and a cross-sectional view of a modified version of the unit cell of FIG. 1, according to another exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The embodiments are described below, in order to explain the aspects of the present invention, by referring to the figures.

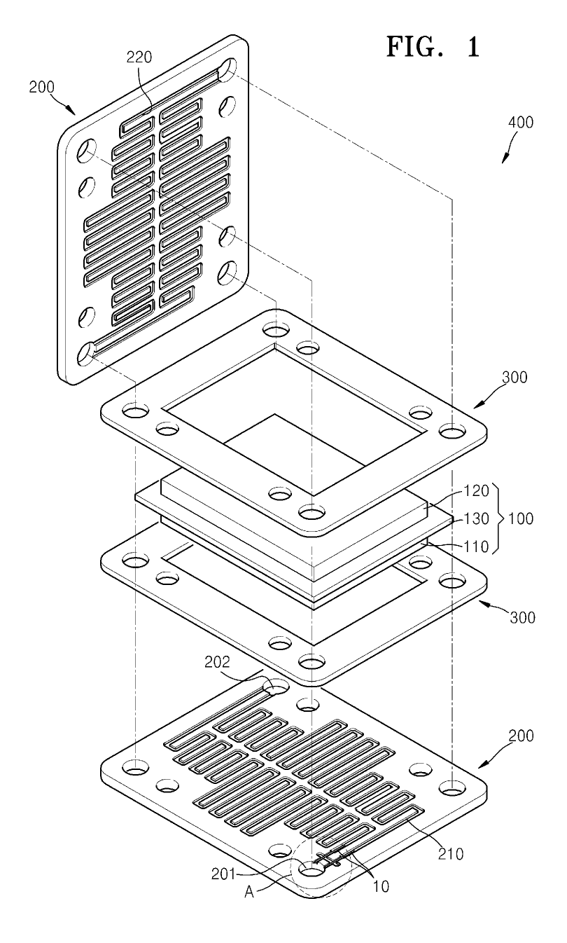

FIG. 1 is an exploded perspective view of a unit cell 400 that constitutes a single layer of a stack of a direct methanol fuel cell (DMFC), according to an exemplary embodiment of the present invention. The unit cell 400 includes: a membrane electrode assembly (MEA) 100, which includes an anode 110, a cathode 120, and an electrolyte membrane 130 disposed therebetween; and a bipolar plate 200 having a flow channel 210 on a first side thereof, through which methanol is supplied to the anode 110, and a flow channel 220 on a second side, through which an oxidant (oxygen from air) flows. The MEA 100 also includes sealing members 300 to prevent the methanol and air from leaking to the outside.

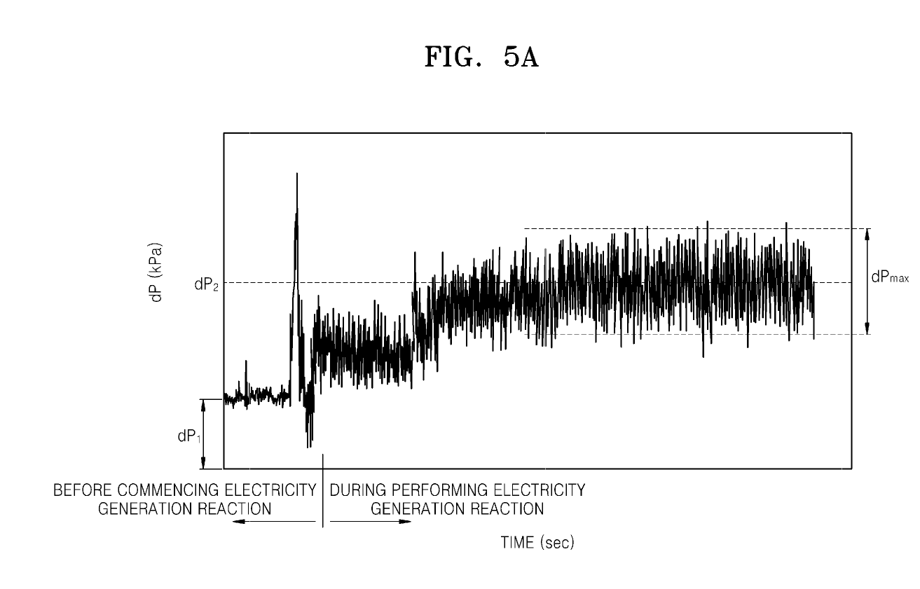

Multiple unit cells 400 are stacked to form a stack 500 (refer to FIG. 4). The methanol is supplied to the anodes 110 of the stack 500, from a fuel supply unit (not shown). When a load (not shown) is applied between the anode 110 and the cathode 120, while methanol and airflow in the flow channels 210 and 220 of the bipolar plate 200, the Reactions 1 and 2, described above, occur between the anode 110 and the cathode 120, and thus, the generated electricity is supplied to the load.

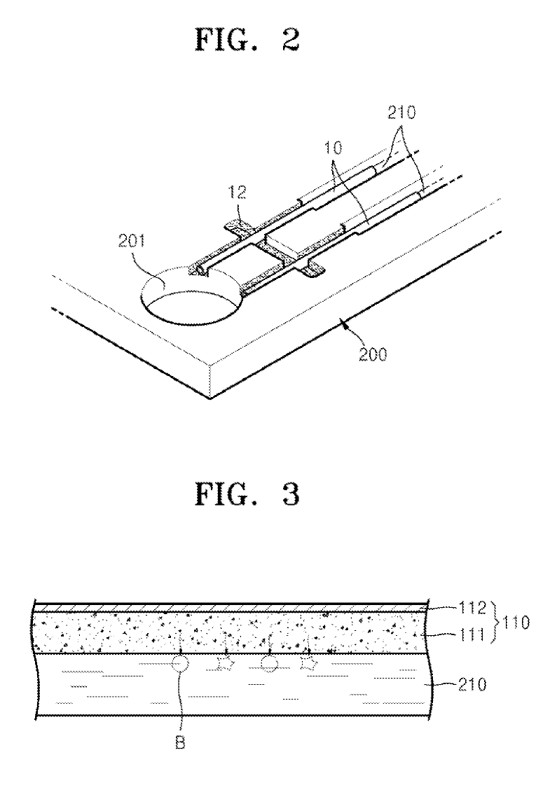

As depicted in FIGS. 1 and 2, capillaries 10, as a flow restrictor that controls the flow of a fluid, are installed on a portion of the flow channel 210, where the methanol enters the flow channel 210, that is, on an inlet 201 of the flow channel 210. The capillaries 10 further increase a pressure difference between the inlet 201 and an outlet of the flow channel 210. The pressure difference reduces the possibility that an unstable supply of methanol is delivered to the anode 110, due to a back-flow of the methanol, during the electricity generation reaction.

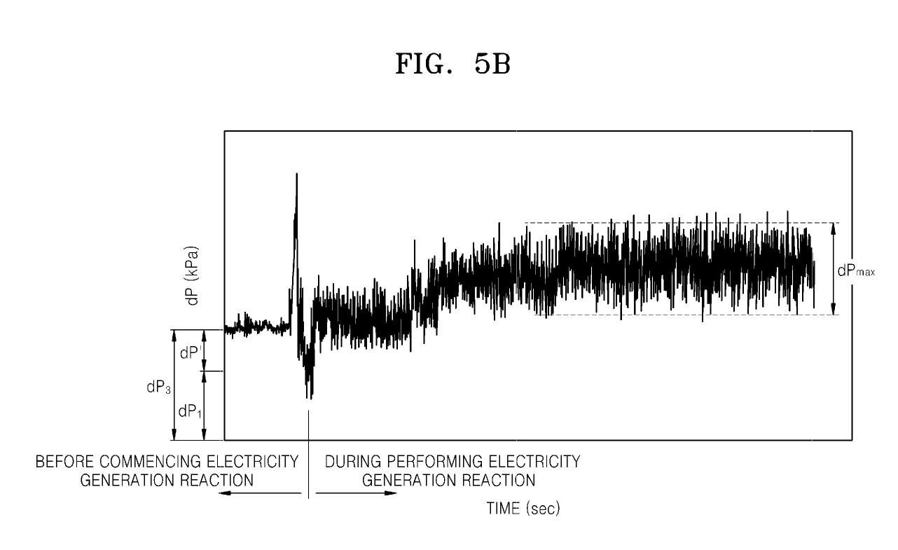

The function of the flow restrictor 10 will now be described further in detail. A case in which the flow restrictor 10 is not formed in the flow channel 210 is firstly described. When pressures of the inlet 201 and the outlet 202 of the flow channel 210 are measured, as depicted in FIG. 5A, the pressure at the inlet 201 is relatively high, and the pressure of the outlet 202 is relatively low. Thus, prior to beginning an electricity generation reaction, when the pressures at the inlet 201 and the outlet 202 are measured, while supplying methanol to the flow channel 210, to determine a pressure difference dP1.

When the electricity generation reaction is performed between the anode 110 and the cathode 120, with an electrical load applied, a pressure difference dP2, which is greater than the pressure difference dP1, is measured between the inlet 210 and the outlet 202 of the flow channel 210. As the electricity generation reaction progresses, CO₂ is generated, and, as a result, the velocity of the fluid is increased. However, not only does the pressure difference increase, a maximum deviation value (dPmax) of the pressure difference dP2 also increases. That is, the difference between a maximum pressure difference value and a minimum pressure difference value is the maximum deviation value dPmax. For example, in the case of the pressure difference dP1, if the maximum deviation between the maximum pressure difference and the minimum pressure difference is approximately 0.2 kPa, the maximum deviation of pressure difference dP2 can be increased to 1 kPa, which is approximately five times greater than the pressure difference dP1.

The reason for the rapid increase in the maximum deviation, is that CO₂ is generated (refer to chemical reaction 1) at the anode 110 during the electricity generation reaction, but is not uniformly generated on the entire region of the flow channel 210. It is ideal that CO₂ is uniformly generated on the entire surface of the anode 110. However, in practice, more of the CO₂ can be generated at the inlet 201 than the outlet 202 of the flow channel 210, or vice versa. If the generation of CO₂ at the inlet 201 is greater than at the outlet 202, an average velocity of the fluid in the flow channel 210 is increased, and thus, the pressure in the flow channel 210 is increased. If the generation of CO₂ at the outlet 202 is greater than the inlet 201, the average velocity of the fluid in the flow channel 210 is decreased, and thus, the pressure in the flow channel 210 is reduced. From these reasons, when the electricity generation reaction is performed, the pressure deviation between the inlet 201 and the outlet 202 greatly increases.

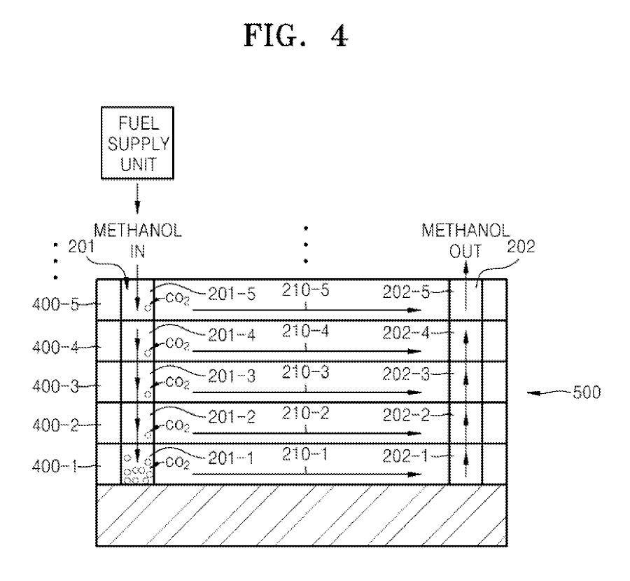

As depicted in FIG. 3, the breaking of bubbles B in the flow channel 210, when CO₂ leaves a gas diffusion layer 111, can be another reason for a large fluctuation of the pressure deviation. The anode 110 includes a catalyst layer 112 on which the chemical reaction 1 is performed, and the gas diffusion layer 111, which is stacked on the catalyst layer 112, and is a hydrophilic porous layer. When the CO₂ generated at the catalyst layer 112 is discharged to the flow channel 210, through the gas diffusion layer 111, the bubble breaking phenomenon occurs, and at this point, the pressure fluctuates.

Due to the above reasons, there is a large pressure deviation between the inlet 201 and the outlet 202 flow channel 210, through which methanol is supplied to the anode 110 when the electricity generation reaction is commenced. Such a large pressure deviation is formed in each of the unit cells 400. Thus, a mechanism for reducing the pressure difference between adjacent inlets 201 and outlets 202 of the flow channels 210 occurs in the stack 500.

As schematically depicted in FIG. 4, the circulation of methanol is repeated, such that the methanol that enters through the inlets 201-1, 201-2, 201-3, . . . 201-n of the unit cells 400-1, 400-2, 400-3 . . . 400-n, and leaves the flow channels 210 through the outlets 202-1, 202-2, 202-3, . . . 202-n. Due to the pressure deviation between the inlets 201 and the outlets 202 of each of the unit cells 400, a pressure difference is generated between the adjacent inlets 201 and outlets 202 of the unit cells 400-1, 400-2, 400-3 . . . 400-n.

If the pressure deviation between the inlet 201 and the outlet 202 in a unit cell (for example, in the unit cell 400-2) is high, and the pressure difference between the adjacent unit cells (for example, 400-1 and 400-3) is low, it can be said that the pressure difference dPmax, between the adjacent unit cells (for example, between 400-2 and 400-1 or 400-3), is a maximum pressure deviation value. In this case, the pressure differences between the unit cells (for example, between 400-2 and 400-1 or 400-3), can be reduced by changing the amount of methanol entering the inlet 201-2 of the unit cell 400-2, which has a relatively high pressure. That is, the pressure is reduced by reducing the amount of methanol entering the inlet 201-2 of the unit cell 400-2, which had a relatively high pressure. As a result, the pressure difference between the adjacent unit cells 400-2 and 400-1 or 400-3 is reduced. Based on the same logic, if the pressure of the unit cell 400-2 is reduced, the amount of methanol entering the inlet 201 of the unit cell 400-2 will be increased.

It is desirable to have pressure difference between the adjacent unit cells 400-2 and 400-1 or 400-3 be fully alleviated by the reducing and/or increasing of the amount of methanol entering the inlets 201. However, varying the supply of methanol may not fully alleviate the pressure difference. In order to remove remaining pressure difference between the unit cells, a portion of the fluid in the flow channel 210-2 may flow back towards the inlet 201-2 of the unit cell 400-2, which has a relatively high pressure. That is, the pressure at the inlet 201-2 is reduced, by the methanol flowing back to the inlet 201-2 of the flow channel 210-2. At this point, CO₂ generated at the anode 110 flows back with the methanol, and may collect at the inlet 201-1 of the flow channel 210-1.

As depicted in FIG. 4, the CO₂ is mainly collected near the inlet 201-1 of the unit cell 400-1, which is last to receive the methanol. This accumulation of CO₂ can prevent the methanol from entering the unit cell 400-1, and eventually, the electricity generation reaction may be hindered. When an output voltage of each of the unit cells 400-2 and 400-1 or 400-3 . . . is measured, it is observed that the output voltage of the unit cell 400-1, which is last to receive the methanol, is gradually reduced. This is understood to be the result of the back flow of the methanol, so as to reduce the pressure difference described above.

The capillaries 10, which are a flow restrictor to prevent the back-flow of the methanol, are used to prevent the above problems. As depicted in FIG. 2, the capillaries 10 are installed on an inlet side of the flow channel 210, so that the methanol entering the inlet 201 of the flow channel 210 flows through the capillaries 10. Silicon 12 is used to fix the capillaries 10, and to fill a gap between the flow channel 210 and the capillaries 10. Thus, since the fluid must flow through the capillaries 10, the pressure at the inlet side is increased. As a result, the pressure difference between the inlet 201 and the outlet 202 is increased.

Assuming that before the electricity generation reaction is conducted, the pressure difference between the inlet 201 and the outlet 202 of the flow channel 210 without the capillaries 10 is dP1, and the pressure difference between an inlet and an outlet of the capillaries 10 is dP′. When the capillaries 10 are formed on the flow channel 210, the pressure difference between the inlet 201 and the outlet 202 of the flow channel 210 is increased to dP1+dP′ (hereinafter, dP1+dP′=dP3). That is, the pressure difference is increased, according to the increased pressure difference between the inlet and the outlet of the capillaries 10. If the pressure difference dP3 is greater than the maximum pressure deviation dPmax, during the electricity generation reaction as described above, the pressure difference between the adjacent unit cells can be sufficiently reduced, by reducing the flow rate of methanol to a unit cell having a relatively high pressure, which is expressed in FIG. 5B.

FIGS. 5A and 5B are graphs respectively showing pressure differences in a DMFC without a flow restrictor, and with a flow restrictor, according to an exemplary embodiment of the present invention. When methanol is supplied to the flow channel 210, before commencing the electricity generation reaction, a pressure difference of dP1 occurs without the flow restrictor and a pressure difference of dP3 occurs with the flow restrictor. The pressure difference dP3 is the sum of the pressure difference dP′, which is the pressure difference between the inlet and outlet of the capillaries 10, and the pressure difference dP1, which is measured between the inlet 201 and the outlet 202 of the flow channel 210. When the electricity generation reaction is commenced, methanol is consumed, and CO₂ is generated. At this point, the average pressure difference dP2 is increased, and also, the maximum pressure deviation dPmax is increased, in both cases.

However, if the pressure difference dP3, is greater than the maximum pressure deviation dPmax, that is, dP3>dPmax, the maximum pressure deviation dPmax can be resolved solely by reducing the flow rate of methanol to the flow channel 210. That is, if the flow rate of the methanol is reduced, the base pressure difference dP3 is reduced, and thus, the maximum pressure deviation dPmax, during the electricity generation reaction, is reduced. Thus, when the flow rate of the methanol is reduced, so that the maximum pressure deviation dPmax is compensated for, by the reduction of pressure difference dP3, the pressure difference between the adjacent unit cells can be alleviated.

Since the pressure difference between the adjacent unit cells can be the maximum pressure deviation dPmax, if the flow rate of the methanol is reduced, the pressure difference can be reduced by the maximum pressure deviation dPmax. The pressure deviation can be alleviated, since the pressure at the inlet 201 of the flow channel 210 is reduced. At this point, if the pressure difference dP3 is smaller than the maximum pressure deviation dPmax, the pressure difference dP3 cannot be reduced, by the maximum pressure deviation dPmax.

In order to compensate for the insufficient pressure reduction, the back flow of the fluid can additionally occur. However, if the pressure difference dP3 is set to be greater than the maximum pressure deviation dPmax, by installing the capillaries 10, a resulting reduction of the flow rate of the methanol can reduce the pressure difference between the adjacent unit cells. Accordingly, the accumulation of the CO₂ can be prevented, since the backflow of the fluid is prevented.

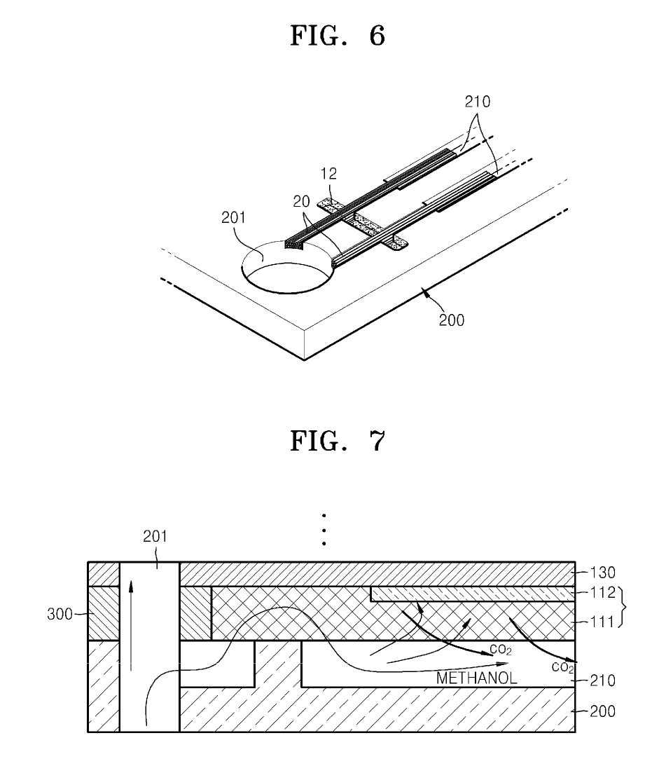

FIG. 6 is a perspective view of a modified version of the structure of the unit cell of FIG. 1, according to another exemplary embodiment of the present invention. As depicted in FIG. 6, the flow restrictor can be a wick bundle 20, through which the fluid (methanol) can flow. The pressure difference dP3 is increased by the wick bundle 20, so as to be greater than the maximum pressure deviation dPmax.

FIG. 7 is a cross-sectional view of a modified version of the structure of the unit cell of FIG. 1, according to another exemplary embodiment of the present invention. Referring to FIG. 7, the flow restrictor can be a portion of the gas diffusion layer 111 of the anode 110. Methanol that has entered through the inlet 201 of the bipolar plate 200 enters the flow channel 210, by passing a portion of the gas diffusion layer 111, instead of passing through an additional member, such as, the capillaries 10, or the wick bundle 20. Since the gas diffusion layer 111 is a hydrophilic porous layer, the gas diffusion layer 111 can be used as the flow restrictor.

Also, at this point, the pressure difference dP3, resulting from the gas diffusion layer 111, should be greater than the maximum pressure deviation dPmax (dP3>dPmax). However, as depicted in FIG. 7, the catalyst layer 112 should not be disposed adjacent to a portion of the gas diffusion layer 111 through which the incoming methanol flows, in order to prevent the methanol from reacting before entering the flow channel 210, and thereby producing CO₂ that may enter an adjacent unit cell.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A direct methanol fuel cell (DMFC) stack comprising:
an anode, a cathode, and a membrane stacked between the anode and the cathode;
a bipolar plate having a flow channel to supply a fluid to the anode; and
a flow restrictor installed in the flow channel, to restrict the flow of the fluid through the flow channel.

2. The DMFC stack of claim 1, wherein the flow restrictor is disposed adjacent to an inlet of the flow channel.

3. The DMFC stack of claim 1, wherein the flow restrictor comprises capillaries through which the fluid flows.

4. The DMFC stack of claim 1, wherein the flow restrictor comprises a wick bundle through which the fluid flows.

5. The DMFC stack of claim 1, wherein the flow restrictor comprises a porous member.

6. The DMFC stack of claim 1, wherein the flow restrictor is a portion of a gas diffusion layer that is disposed on the anode.

7. The DMFC stack of claim 6, wherein a catalyst layer is not disposed adjacent to the portion of the gas diffusion layer.

8. The DMFC stack of claim 1, wherein the flow restrictor restricts the flow of the fluid, so that a pressure difference between an inlet and an outlet of the flow channel, before performing an electricity generation reaction in the DMFC, is greater than a maximum deviation of the pressure difference between the inlet and the outlet of the flow channel, when performing the electricity generation reaction.

9. A direct methanol fuel cell (DMFC) comprising:
a stack of unit cells comprising an anodes, a cathodes, and a membranes disposed therebetween;
bipolar plates disposed on the unit cells, having flow channels to supply a fuel to the anodes; and
flow restrictors installed in the flow channels, to restrict the flow of the fuel; and
a fuel supply unit that supplies the fuel to the flow channels.

10. The DMFC of claim 9, wherein the flow restrictors are disposed adjacent to inlets of the flow channels.

11. The DMFC of claim 9, wherein the flow restrictors comprise capillaries through which the fuel flows.

12. The DMFC of claim 9, wherein the flow restrictors comprises wick bundles through which the fuel flows.

13. The DMFC of claim 9, wherein the flow restrictors comprise porous members.

14. The DMFC of claim 9, wherein flow restrictors are portions of gas diffusion layers that are disposed on the anodes.

15. The DMFC of claim 14, wherein catalyst layers are not formed adjacent to the portions of the gas diffusion layers.

16. The DMFC of claim 9, wherein the flow restrictor restricts the flow of the fuel, so that a pressure difference between an inlet and an outlet of the flow channel, before performing an electricity generation reaction in the DMFC, is greater than a maximum deviation value of the pressure difference between the inlet and the outlet of the flow channel, when performing the electricity generation reaction.
